(19) United States
(12) Patent Application Publication
(10) Pub. No.: US 2016/0320953 A1
(43) Pub. Date: Nov. 3, 2016

(54) Method and Device for Amplifying Selected Region of Previewing Interface

(71) Applicant: ZTE CORPORATION, Shenzhen City, Guangdong Province (CN)

(72) Inventor: Mingdong PAN, Shenzhen (CN)

(21) Appl. No.: 15/104,990

(22) PCT Filed: Apr. 18, 2014
(86) PCT No.: PCT/CN2014/075690

§ 371 Date: Jun. 16, 2016

(30) Foreign Application Priority Data
Dec. 23, 2013 (CN) 201310719988.2

(51) Int. Cl. G06F 3/0484; H04N 5/232; G06F 3/0488

(52) U.S. Cl. CPC G06F 3/04845; G06F 3/04883; H04N 5/23293; H04N 5/23216

(57) ABSTRACT

A method for amplifying a selected region of a preview interface, applied to a touch screen terminal having a photographing function or/and a shooting function, includes: after the photographing function or the shooting function of the terminal is enabled and the preview interface is displayed on a touch screen, detecting a touch operation of a user on the preview interface; and after the touch operation of the user in a designated region on the preview interface is detected, amplifying display content of the designated region according to a preset proportion, and dragging an edge of a display frame, so that the selected designated region can be enlarged or reduced. The embodiments of the present document further disclose an apparatus for amplifying a selected region of a preview interface, which corresponds to the method described above.

### TECHNICAL FIELD

The present document relates to the field of terminal shooting, and in particular, to a method and apparatus for amplifying a selected region of a preview interface.

### BACKGROUND OF THE RELATED ART

Currently, mobile phones basically have a photographing and shooting function, which is one of commonly-used functions for people. During photographing and shooting, a preview interface will be presented on a screen of a mobile phone. There is a function of amplifying preview content in a currently-used menu of the mobile phone. During preview for photographing, a button corresponding to the amplification function may be dragged to amplify the preview content. Further, there is a function of selecting a rectangular frame for amplification and display on the preview interface. However, the above manners have some defects more or less. For example, a function key may shield the preview content to some extent; only a center of the preview region can be amplified; and if a rectangular region is selected, content to be amplified in the region is fixed and a size of the region required to be amplified cannot be changed, and if the size of the selected rectangular region is not suitable, the rectangular region needs to be re-selected, which is not convenient to operate.

### SUMMARY

In order to solve the above technical problems, the present document discloses a method and apparatus for amplifying a selected region of a preview interface. No separate amplification button is needed, which enables the preview interface to be neater, and an enlargement/reduction function of the selected region is added, which enables the user to adjust a size of the selected region according to the actually amplified display content, thereby it is easy for the user to accurately select the content required to be amplified on the preview interface. The specific technical solutions are as follows.

The embodiments of the present document disclose a method for amplifying a selected region of a preview interface, applied to a touch screen terminal having a photographing function or/and a shooting function, comprising:
after the photographing function or the shooting function of the terminal is enabled and the preview interface is displayed on a touch screen, detecting a touch operation of a user on the preview interface; and
after the touch operation of the user in a designated region on the preview interface is detected, amplifying a display content of the designated region according to a preset proportion.

Preferably, after amplifying a display content of the designated region according to a preset proportion, the method comprises: displaying the amplified display content of the designated region on the touch screen.

Preferably, after the touch operation of the user in a designated region on the preview interface is detected, amplifying a display content of the designated region according to a preset proportion comprises:
after the touch operation of the user in the designated region on the preview interface is detected, focusing on a center of the designated region; and
after the center of the designated region is focused and a clear display content is obtained, amplifying the display content.

Preferably, after the amplified display content of the designated region is displayed on the touch screen, the method comprises:
detecting whether there is a touch operation on an edge of the amplified designated region; and
if yes, enlarging or reducing the designated region according to a displacement trajectory of the touch operation.

Preferably, after the amplified display content of the designated region is displayed on the touch screen, the method comprises:
detecting whether there is a touch operation within the amplified designated region;
if yes, determining a type of the touch operation; and
enlarging or reducing the designated region in accordance with a preset coefficient according to the type of the touch operation.

Preferably, detecting whether there is a touch operation on an edge of the amplified designated region comprises:
after a press-down operation and a lift-up operation of the user on the touch screen are detected, recording coordinates of the press-down operation and the lift-up operation on the touch screen;
judging whether the coordinates of the press-down operation are on the edge of the amplified designated region; and
if the coordinates of the press-down operation are on the edge of the amplified designated region, determining that the touch operation is on the edge of the designated region and determining the displacement trajectory.

Preferably, detecting whether there is a touch operation within the amplified designated region and if yes, determining a type of the touch operation comprises:
after a press-down operation and a lift-up operation of the user on the touch screen are detected, recording coordinates of the press-down operation and the lift-up operation on the touch screen;
if the coordinates of the press-down operation are within the amplified designated region, calculating a number of times of the press-down operation within the amplified designated region for a preset period of time; and
determining the type of the touch operation according to the number of times of the press-down operation.

The embodiments of the present document disclose an apparatus for amplifying a selected region of a preview interface, comprising:
a touch operation detection module configured to detect a touch operation of a user on the preview interface after a photographing function or a shooting function of a terminal is enabled and the preview interface is displayed on a touch screen; and
an amplification module configured to amplify a display content of a designated region on the preview interface according to a preset proportion after the touch operation of the user in the designated region is detected by the touch operation detection module.

Preferably, the touch operation detection module is further configured to detect a press-down operation and a lift-up operation of the user on the touch screen, and record coordinates of the press-down operation and the lift-up operation on the touch screen; and
the apparatus further comprises a display module configured to display the display content amplified by the amplification module on the touch screen.

Preferably, the apparatus further comprises: a region enlargement/reduction module configured to, when there is a touch operation on an edge of the amplified designated region, enlarge or reduce the designated region according to a displacement trajectory of the touch operation; or
when there is a touch operation within the amplified designated region, determine a type of the touch operation, and enlarge or reduce the designated region in accordance with a preset coefficient according to the type of the touch operation.

The positive progress effects of the embodiments of the present document are as follows. In the embodiments of the present document, a designated region of a user on a touch screen can be amplified without a separate amplification icon. After the amplification, the user can randomly change a size of a region required to be amplified by directly dragging an edge of a display frame, or enlarge or reduce the region required to be amplified according to a certain proportion by clicking within the display frame, without designating regions many times because an appropriate amplified region cannot be selected, thereby facilitating the operation of the user and improving the user experience.

### BRIEF DESCRIPTION OF DRAWINGS

FIG. 1 is a flowchart of a method for amplifying a selected region according to embodiment one of the present document;

FIG. 2 is a flowchart of a method for amplifying a selected region according to embodiment two of the present document;

FIG. 3 is a flowchart of a method for enlarging or reducing the amplified selected region according to embodiment three of the present document;

FIG. 4 is a flowchart of a method for enlarging or reducing the amplified selected region according to embodiment four of the present document;

FIG. 5 is a flowchart of a method for enlarging or reducing the amplified selected region according to embodiment five of the present document;

FIG. 6 is a block diagram of an apparatus for amplifying a selected region according to embodiment six of the present document;

FIG. 7 is a block diagram of an apparatus for amplifying a selected region according to embodiment seven of the present document;

FIG. 8 is a diagram of an original preview interface according to embodiment one of the present document;

FIG. 9 is a diagram of a designated region on the preview interface in FIG. 8 according to embodiment one of the present document;

FIG. 10 is a diagram of amplifying and displaying display content of the designated region in FIG. 9 according to embodiment one of the present document;

FIG. 11 is a diagram of enlarging display content of the designated region in FIG. 10 according to embodiment three of the present document;

FIG. 12 is a diagram of a process of enlarging display content of the designated region in FIG. 10 according to embodiment four of the present document;

FIG. 13 is a diagram of enlarging and then displaying display content of the designated region in FIG. 10 according to embodiment four of the present document;

FIG. 14 is a diagram of a process of enlarging display content of the designated region in FIG. 10 in accordance with a preset coefficient according to embodiment five of the present document; and

FIG. 15 is a diagram of enlarging and then displaying display content of the designated region in FIG. 10 in accordance with a preset coefficient according to embodiment five of the present document.

### PREFERRED EMBODIMENTS

The embodiments of the present document will be described in detail below in conjunction with accompanying drawings. It should be illustrated that the embodiments in the present application and the features in the embodiments can be combined with each other randomly without a conflict.

### Method Embodiments

### Embodiment One

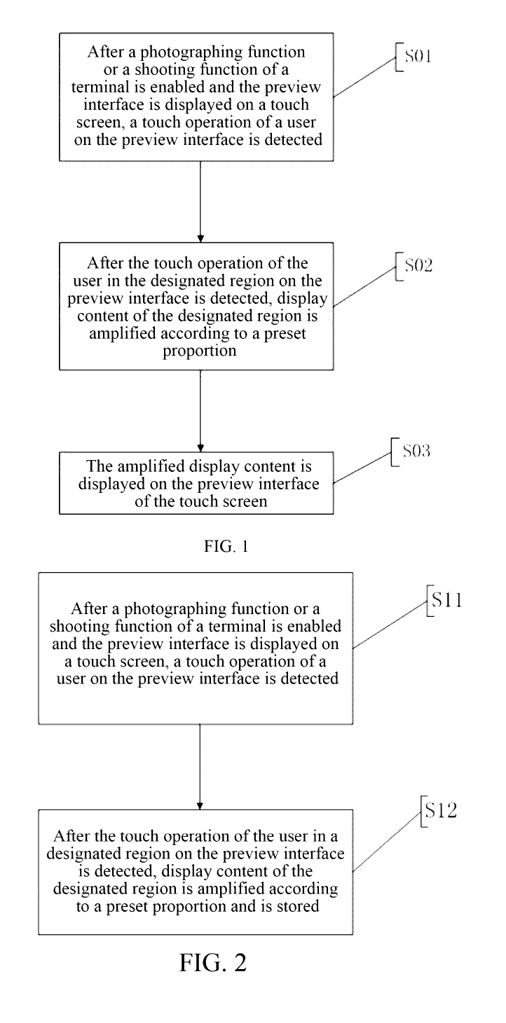

In the embodiment of the present document, a method for amplifying a selected region of a preview interface is disclosed. As shown in FIG. 1, the method comprises the following steps.

In S01, after a photographing function or a shooting function of a terminal is enabled and the preview interface is displayed on a touch screen, a touch operation of a user on the preview interface is detected.

In a specific operation, a photographing or shooting function of a terminal is firstly enabled. Thereafter, a preview interface will be displayed on a touch screen of the terminal, as shown in FIG. 8. A user may implement an operation of designating a region on the touch screen. The present embodiment discloses a method for amplifying a selected region of a preview interface, i.e., detecting a press-down operation and a lift-up operation of the user on the touch screen, and recording coordinates of the press-down operation and the lift-up operation on the touch screen. By taking a left upper corner of the touch screen as a zero point of coordinates, and when the coordinates of the press-down operation on the touch screen are different from the coordinates of the lift-up operation on the touch screen, a rectangular region is formed with a line connecting the coordinates of the two points as a diagonal line. The rectangular region has a length of |X1−X0 |, and a width of |Y1−Y0|, wherein (X1, Y1) are the coordinates of the lift-up operation, and (X0, Y0) are the coordinates of the press-down operation (in all embodiments, the left upper corner of the screen is used as the origin of coordinates and is enlarged to the X axis and the Y axis).

Further, when the coordinates of the press-down operation on the touch screen are different from the coordinates of the lift-up operation on the touch screen, the coordinates of the press-down operation may also be used as a center of a circle, and a circular region is formed with a line connecting the coordinates of the two points as a radius. The circle has a radius of r=\sqrt{(X2−X3)²+(Y2−Y3)2}, wherein (X2, Y2) are the coordinates of the press-down operation, and (X3, Y3) are the coordinates of the lift-up operation.

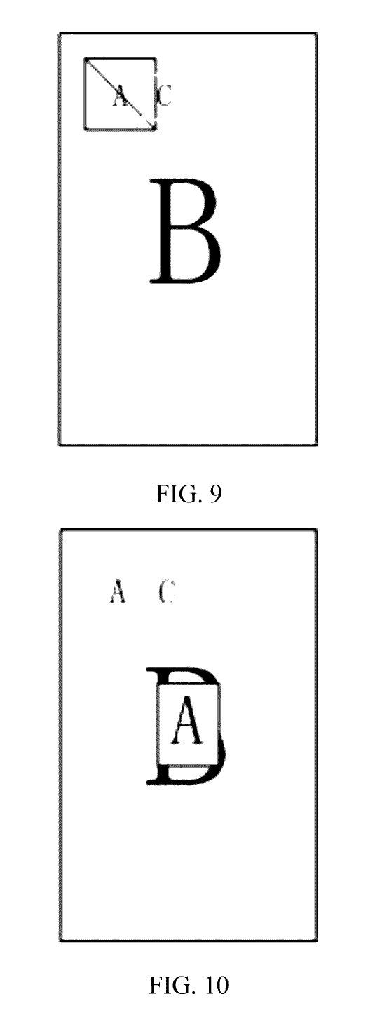

When a user needs to designate a region, the user only needs to implement an operation of drawing a line on the touch screen to form a rectangular or circular region, as shown in FIG. 9, which is convenient to operate. Of course, a graph which is drawn in such way is not limited to the rectangle or circle, and instead, the graph may also be in another shape. Similarly, the designated region may also be determined by using other operations except the operation of drawing a line.

In S02, after the touch operation of the user in the designated region on the preview interface is detected, display content of the designated region is amplified according to a preset proportion.

The content of the determined designated region is amplified according to a coefficient preset by the user in setting options or according to a preset coefficient when leaving factory, for example, 2 or 4. If the designated region is a rectangle, a focusing operation is performed with a central point of the rectangle as a focus, for example, a horizontal coordinate of the center of the rectangular region in S01 is (X1−X0)/2, and a longitudinal coordinate of the center is (Y1−Y0)/2. If the designated region is a circle, a focusing operation is performed with a center of the circle as a focus, for example, coordinates of the center of the circle in S01 is (X1, Y1).

In S03, the amplified display content is displayed on the preview interface of the touch screen.

The content of the amplified and focused designated region is displayed on an upper layer of the preview interface, as shown in FIG. 10. For example, the amplification coefficient is 2 at this time (the amplification coefficient is 2 in the following embodiments). The amplified display region is a region enclosed by (x, y), wherein, X4≦x≦X5 and Y4≦y≦Y5. A distance between X4 and X5 is 2*(X1−X0), and a distance between Y4 and Y5 is 2*(Y1−Y0).

After the designated region is amplified and displayed on the upper layer of the preview interface, if the user wants to return back to the original preview interface, the user may touch a region outside the amplified and displayed designated region. That is, after the terminal detects a further press-down operation and a further lift-up operation of the user on the touch screen, the terminal judges whether the coordinates of the lift-up operation and the press-down operation are outside the amplified and displayed designated region, and if so, recovers the preview interface on the touch screen to the original interface. Of course, other ways for triggering recovery to the original interface may also be set.

The embodiment will be further described below by way of example with reference to FIGS. 8, 9 and 10. FIG. 8 is an original preview interface having A and B thereon. At this time, if a user wants to amplify A on the left upper corner of the screen, a region where A is located may be designated (as shown in FIG. 9). According to presetting of the user or factory setting, assuming that the amplification coefficient is 2, display content in the region where A is located is amplified by 2. FIG. 10 is a diagram of amplifying and then displaying the content in the region where A is located.

### Embodiment Two

The present embodiment discloses a method for amplifying a selected region of a preview interface. As shown in FIG. 2, the method comprises the following steps.

In S11, after a photographing function or a shooting function of a terminal is enabled and the preview interface is displayed on a touch screen, a touch operation of a user on the preview interface is detected.

In S12, after the touch operation of the user in a designated region on the preview interface is detected, display content of the designated region is amplified according to a preset proportion and is stored.

The present embodiment differs from embodiment one primarily in that in the present embodiment, after the content of the designated region is amplified, the content is directly imaged and stored, i.e., amplifying and photographing the designated region of the user and then returning to the preview interface to wait for other operations.

### Embodiment Three

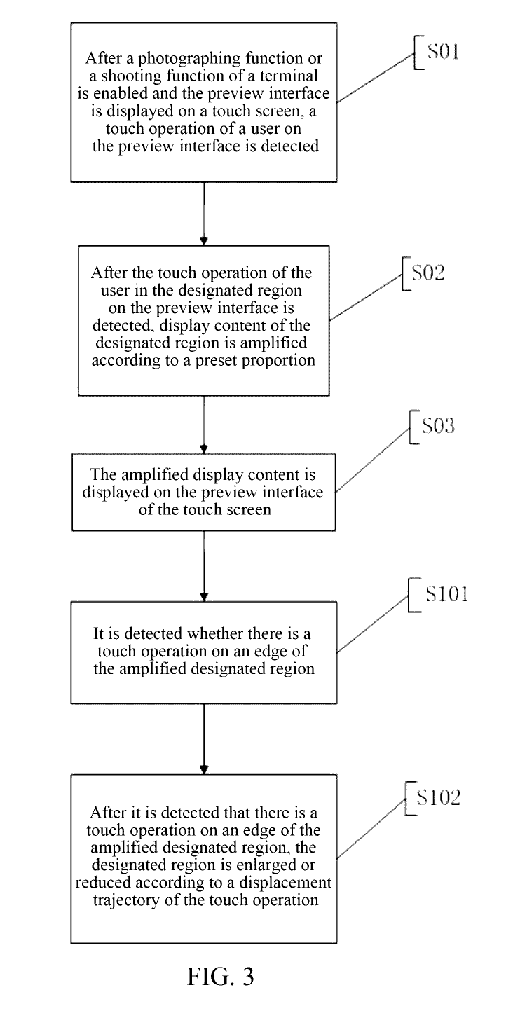

The present embodiment discloses a method for amplifying a selected region of a preview interface, which is implemented on the basis of the above embodiment one, i.e., reducing or enlarging the designated region in embodiment one. As shown in FIG. 3, the method comprises the following steps.

In S101, it is detected whether there is a touch operation on an edge of the amplified designated region.

An operation of the user on the edge of the amplified region is preferably as follows.

Firstly, after a press-down operation and a lift-up operation of the user on the touch screen are detected, coordinates of the press-down operation and the lift-up operation on the touch screen are recorded, and it is judged whether the coordinates are on an edge of the amplified region. For example, the coordinates of the press-down operation are (X6, Y6) and the coordinates of the lift-up operation are (X7, Y7). In S01, if the designated region is a rectangle, the content in the amplified and focused designated region will be displayed on an upper layer, and the displayed region is a region enclosed by (x, y), wherein X4≦x≦X5 and Y4≦y≦Y5. A distance between X4 and X5 is 2*(X1−X0), and a distance between Y4 and Y5 is 2*(Y1−Y0). At this time, it needs to judge whether (X6, Y6) is on (x, y) and does not coincide with (X4, Y4), (X4, Y5), (X5, Y4) and (X5, Y5). If the requirements are met, it is determined that there is a touch operation on the edge of the amplified designated region.

In S102, after it is detected that there is a touch operation on an edge of the amplified designated region, the designated region is enlarged or reduced according to a displacement trajectory of the touch operation.

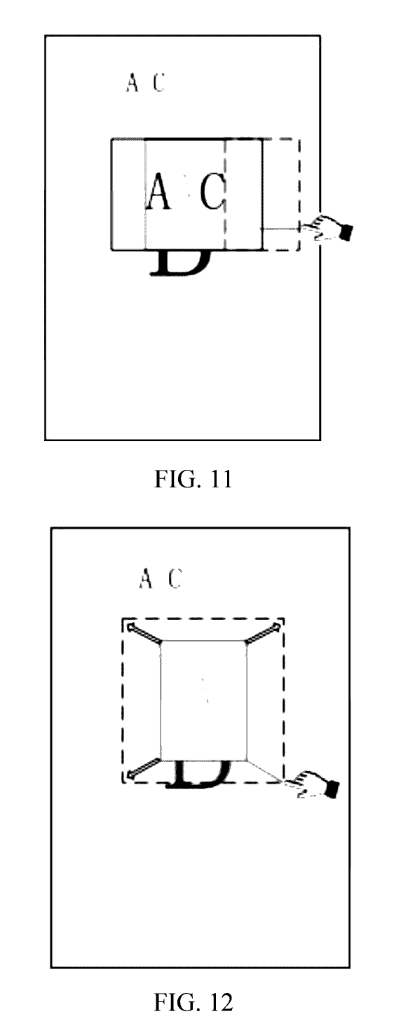

In an actual operation, as shown in FIG. 11, according to the recorded press-down operation (X6, Y6) and lift-up operation (X7, Y7), when a horizontal coordinate of the lift-up operation is greater than a horizontal coordinate of the press-down operation or a longitudinal coordinate of the lift-up operation is less than a longitudinal coordinate of the press-down operation, the operation is an enlargement operation, and a length of the designated region is enlarged by a distance of (X7−X6)/2, and a width of the designated region is enlarged by a distance of (Y6−Y7)/2. When the horizontal coordinate of the lift-up operation is less than the horizontal coordinate of the press-down operation or the longitudinal coordinate of the lift-up operation is greater than the longitudinal coordinate of the press-down operation, the operation is a reduction operation, and the length of the designated region is reduced by a distance of (X6−X7)/2, and the width of the designated region is reduced by a distance of (Y7−Y6)/2. However, the reduction operation has a precondition that the horizontal coordinate X6 of the lift-up operation must be greater than a horizontal coordinate X4 of the left upper corner of the amplified display region, and the longitudinal coordinate Y6 of the lift-up operation must be less than a longitudinal coordinate Y4 of the left upper corner of the amplified display region. Therefore, if the operation is the enlargement operation, the coordinates of the edge of the designated region are changed to (x1, y1), wherein X0≦x1≦X1+|(X7−X6)/2| and Y0≦y1≦Y1+|(Y7−Y6)/2|, and if the operation is the reduction operation, the coordinates of the edge of the designated region are changed to (x1, y1), wherein X0≦x1≦X1−|(X7−X6)/2| and Y0≦y1≦Y1−|(Y7−Y6)/2|. Finally, the designated region is amplified and displayed in accordance with the preset amplification coefficient according to the size of the designated region at this time.

### Embodiment Four

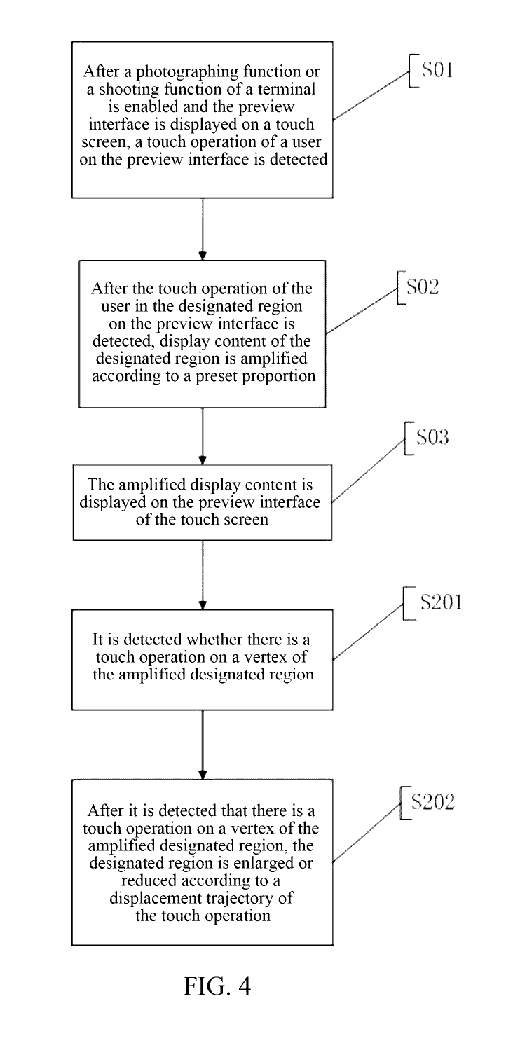

The present embodiment discloses a method for amplifying a selected region of a preview interface, which is implemented on the basis of the above embodiment one and belongs to a special case of embodiment three. Embodiment four has the same effects as those of embodiment three, but has different implementations from those of embodiment three. The method is merely suitable for a condition where the designated region is a rectangle. As shown in FIG. 4, the method comprises the following steps.

In S201, it is detected whether there is a touch operation on a vertex of the amplified designated region.

An operation of the user on the vertex of the amplified region is preferably as follows.

Firstly, after a press-down operation and a lift-up operation of the user on the touch screen are detected, coordinates of the press-down operation and the lift-up operation on the touch screen are recorded, and it is judged whether the coordinates are on a vertex of the amplified region. For example, the coordinates of the press-down operation are (X6, Y6) and the coordinates of the lift-up operation are (X7, Y7). In S01, if the designated region is a rectangle, the content in the amplified and focused designated region will be displayed on an upper layer, and the displayed region is a region enclosed by (x, y), wherein X4≦x≦X5 and Y4≦y≦Y5. The vertexes of the amplified region are (X4, Y4), (X4, Y5), (X5, Y4) and (X5, Y5). At this time, it needs to judge whether (X6, Y6) coincides with any point of (X4, Y4), (X4, Y5), (X5, Y4) and (X5, Y5). If the requirements are met, it is determined that there is a touch operation on the vertex of the amplified designated region, as shown in FIG. 12.

In S202, after it is detected that there is a touch operation on a vertex of the amplified designated region, the designated region is enlarged or reduced according to a displacement trajectory of the touch operation.

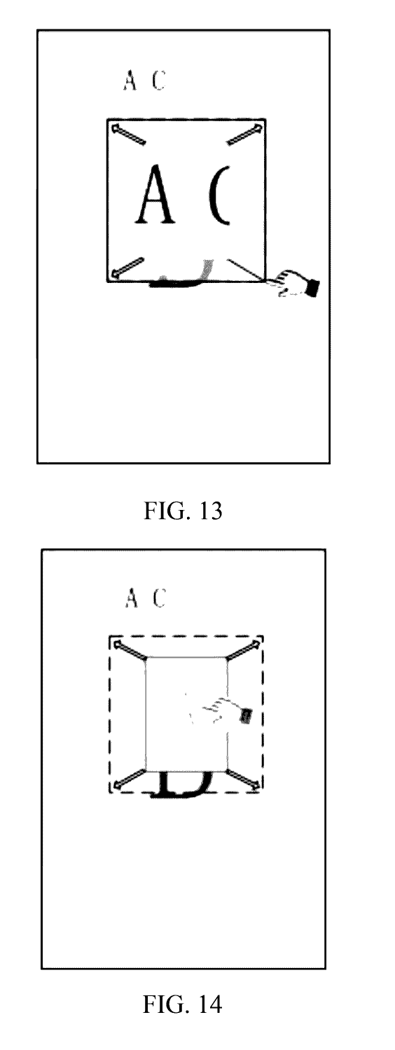

In an actual operation, according to the recorded press-down operation (X6, Y6) and lift-up operation (X7, Y7), when a horizontal coordinate of the lift-up operation is greater than a horizontal coordinate of the press-down operation or a longitudinal coordinate of the lift-up operation is less than a longitudinal coordinate of the press-down operation, the operation is an enlargement operation. When the horizontal coordinate of the lift-up operation is less than the horizontal coordinate of the press-down operation or the longitudinal coordinate of the lift-up operation is greater than the longitudinal coordinate of the press-down operation, the operation is a reduction operation. However, the reduction operation has a precondition that the horizontal coordinate X6 of the lift-up operation must be greater than a horizontal coordinate X4 of the left upper corner of the amplified display region, and the longitudinal coordinate Y6 of the lift-up operation must be less than a longitudinal coordinate Y4 of the left upper corner of the amplified display region. At this time, the edges of the designated region are amplified simultaneously. If the operation is the enlargement operation, the coordinates of the edge of the designated region are changed to (x2, y2), wherein X0−|(X7−X6)/2|≦x2≦X1+|(X7−X6)/2| and Y0−|(Y7−Y6)/2|≦y2≦Y1+|(Y7−Y6)/2|; and if the operation is the reduction operation, the coordinates of the edges of the designated region are changed to (x2, y2), wherein X0+|(X7−X6)/2|≦x2≦X1−|(X7−X6)/2| and Y0+|(Y7−Y6)/2|≦y2≦Y1−|(Y7−Y6)/2|. Finally, the designated region is amplified and displayed in accordance with the preset amplification coefficient according to the size of the designated region at this time, as shown in FIG. 13.

### Embodiment Five

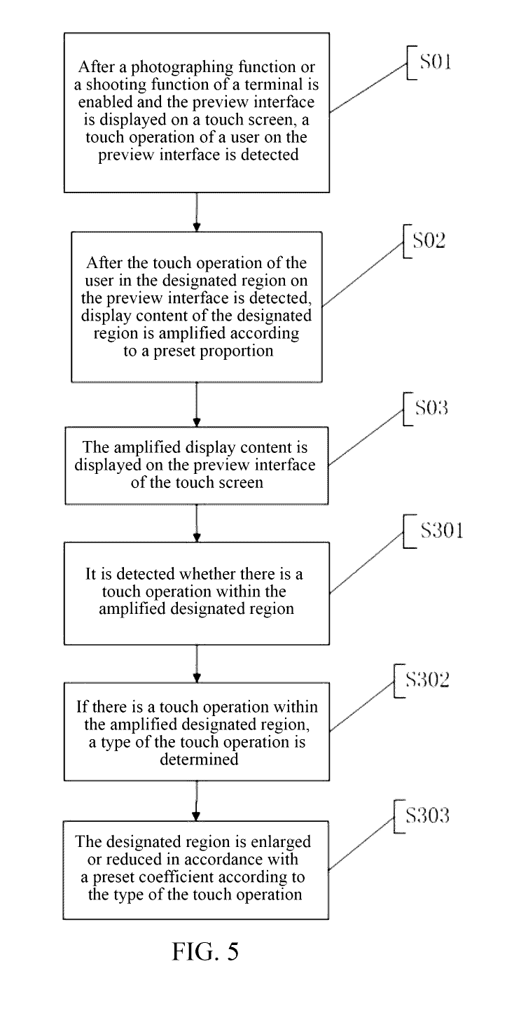

The present embodiment discloses a method for amplifying a selected region of a preview interface, which provides a method having the same effects as those of embodiments three and four but having different operation manners from those of embodiments three and four on the basis of the above embodiments three and four. The present embodiment differs from embodiment three primarily in that in the present embodiment, a movement operation on the edge or vertex of the amplified designated region is modified to a touch operation within the amplified designated region. As shown in FIG. 5, the method comprises the following steps.

In S301, it is detected whether there is a touch operation within the amplified designated region.

A touch operation of the user within the amplified designated region preferably comprises the following steps.

After a press-down operation and a lift-up operation of the user on the touch screen are detected, coordinates of the press-down operation and the lift-up operation on the touch screen are recorded, and it is judged whether the coordinates of the press-down operation and the lift-up operation are within the amplified designated region. For example, the press-down operation and the lift-up operation of the user on the touch screen are detected, and the coordinates (X8, Y8) of the press-down operation and the coordinates (X9, Y9) of the lift-up operation are recorded. In S01, if the designated region is a rectangle, the content in the amplified and focused designated region will be displayed on an upper layer, and the displayed region is a region enclosed by (x, y), wherein X4≦x≦X5 and Y4≦y≦Y5. It is judged whether the coordinates (X8, Y8) of the press-down operation and the coordinates (X9, Y9) of the lift-up operation are within the region enclosed by (x, y), as shown in FIG. 14.

In S302, if there is a touch operation within the amplified designated region, a type of the touch operation is determined.

In an actual operation, if the coordinates of the press-down operation are within the amplified designated region, the number of times of the press-down operation within the amplified designated region for a preset period of time is calculated, and the numbers of times of the press-down operation within the amplified designated region for the preset period of time (for example, 2 s) are accumulated.

In S303, the designated region is enlarged or reduced in accordance with a preset coefficient according to the type of the touch operation.

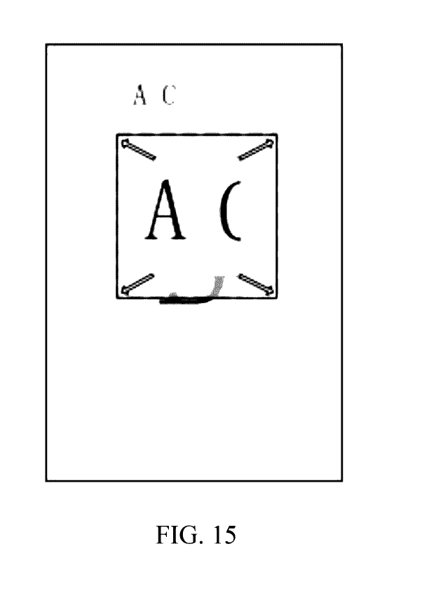

The type of the touch operation is determined according to the number of times of the press-down operation. If the recorded number of times of the press-down operation is 2, it is determined that the touch operation is an enlargement operation at this time; and if the recorded number of times of the press-down operation is 3, it is determined that the touch operation is a reduction operation at this time. The designated region is enlarged or reduced in accordance with a preset proportion according to the type of the touch operation. Wherein, the size of the designated region is adjusted according to the enlargement operation or reduction operation determined in the previous step in accordance with a preset enlargement or reduction coefficient (for example, the enlargement or reduction coefficient is 3 or 6). The effect diagram of the actual operation is shown in FIG. 15.

### Apparatus Embodiments

### Embodiment Six

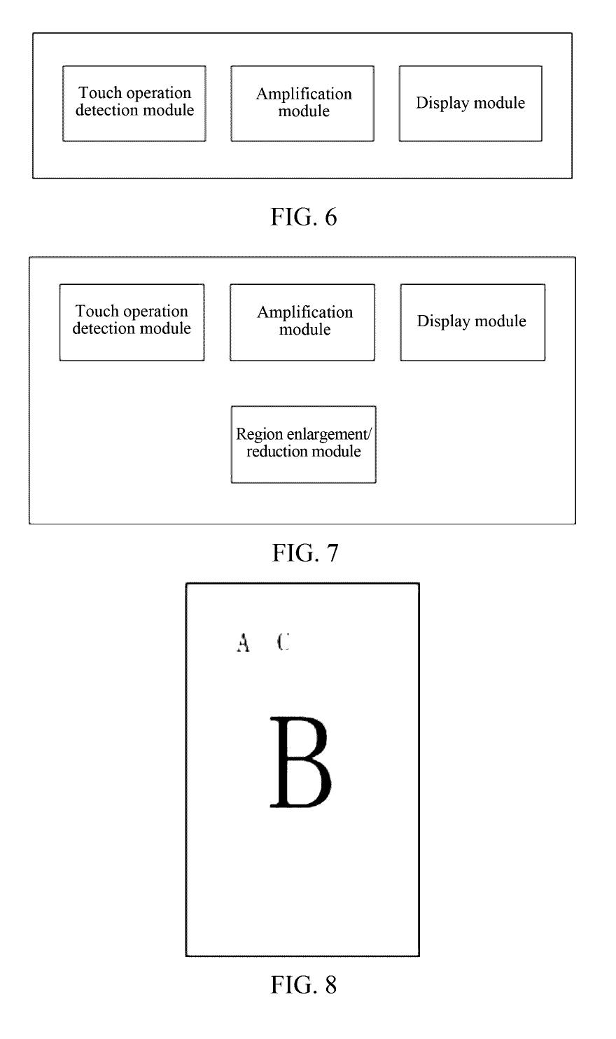

The present embodiment discloses an apparatus for amplifying a selected region of a preview interface, as shown in FIG. 6, comprising:
a touch operation detection module configured to detect a touch operation of a user on the preview interface after a photographing function or a shooting function of a terminal is enabled and the preview interface is displayed on a touch screen;
an amplification module configured to amplify display content of a designated region on the preview interface according to a preset proportion after the touch operation of the user in the designated region is detected by the touch operation detection module; and
a display module configured to display the display content amplified by the amplification module on the touch screen.

### Embodiment Seven

The present embodiment discloses an apparatus for amplifying a selected region of a preview interface, as shown in FIG. 7, comprising:
a touch operation detection module configured to detect a touch operation of a user on the preview interface after a photographing function or a shooting function of a terminal is enabled and the preview interface is displayed on a touch screen;
an amplification module configured to amplify display content of a designated region on the preview interface according to a preset proportion after the touch operation of the user in the designated region is detected by the touch operation detection module;
a display module configured to display the display content amplified by the amplification module on the touch screen; and
a region enlargement/reduction module configured to enlarge or reduce the designated region according to a displacement trajectory of a touch operation when there is the touch operation on an edge of the amplified designated region.

Further, the apparatus may comprise an original interface recovery module configured to close the display content of the amplified designated region and recover the preview interface on the touch screen to the original interface when there is a touch operation outside the amplified designated region.

An operation of the user on the edge of the amplified region is preferably as follows.

After a press-down operation and a lift-up operation of the user on the touch screen are detected, coordinates of the press-down operation and the lift-up operation on the touch screen are recorded, and it is judged whether the coordinates are on an edge of the designated region. For example, in S101, the coordinates of the press-down operation are (X6, Y6) and the coordinates of the lift-up operation are (X7, Y7). In S01, if the designated region is a rectangle, the content in the amplified and focused designated region will be displayed on an upper layer, and the displayed region is a region enclosed by (x, y), wherein X4≦x≦X5 and Y4≦y≦Y5. A distance between X4 and X5 is 2*(X1−X0), and a distance between Y4 and Y5 is 2*(Y1−Y0). At this time, it needs to judge whether (X6, Y6) is on (x, y) and does not coincide with (X4, Y4), (X4, Y5), (X5, Y4) and (X5, Y5). If the requirements are met, it is determined that there is a touch operation on the edge of the amplified designated region.

An operation of the user on the vertex of the amplified region is preferably as follows.

After a press-down operation and a lift-up operation of the user on the touch screen are detected, coordinates of the press-down operation and the lift-up operation on the touch screen are recorded, and it is judged whether the coordinates are on a vertex of the amplified region. For example, in S101, the coordinates of the press-down operation are (X6, Y6) and the coordinates of the lift-up operation are (X7, Y7). In S01, if the designated region is a rectangle, the content in the amplified and focused designated region will be displayed on an upper layer, and the displayed region is a region enclosed by (x, y), wherein X4≦x≦X5 and Y4≦y≦Y5. The vertexes of the amplified region are (X4, Y4), (X4, Y5), (X5, Y4) and (X5, Y5). At this time, it needs to judge whether (X6, Y6) coincides with any point of (X4, Y4), (X4, Y5), (X5, Y4) and (X5, Y5). If the requirements are met, it is determined that there is a touch operation on the vertex of the amplified designated region.

A person having ordinary skill in the art can understand that all or part of steps in the above embodiments can be implemented by computer program flow, which can be stored in a computer readable storage medium, is performed on a corresponding hardware platform (for example, a system, a device, an apparatus, and a component etc.), and when performed, comprises one of steps of the method embodiment or a combination thereof.

Alternatively, all or part of steps in the above embodiments can also be implemented by integrated circuits, they can be respectively made into a plurality of integrated circuit modules; alternatively, and they are implemented with making several modules or steps of them into a single integrated circuit module. Thus, the present document is not limited to any specific combinations of hardware and software.

Each module, functional module or functional unit in the aforementioned embodiments can be implemented with general computing apparatuses, and can be integrated in a single computing apparatus, or distributed onto a network consisting of a plurality of computing apparatuses.

When each module, functional module or functional unit in the aforementioned embodiments is implemented in a form of software functional modules and is sold or used as an independent product, it can be stored in a computer readable storage medium, which may be a read-only memory, a disk or a disc etc.

Changes or substitutions can easily be conceived by a person having ordinary skill in the art within the technical scope disclosed by the present document, and should be included in the protection scope of the present document. Therefore, the protection scope of the present document is defined by the protection scope of the claims.

### INDUSTRIAL APPLICABILITY

In the embodiments of the present document a designated region of a user on a touch screen can be amplified without a single amplification icon. After the amplification, the user can randomly change a size of a region required to be amplified by directly dragging an edge of a display frame, or enlarge or reduce the region required to be amplified according to a certain proportion by clicking within the display frame, without designating regions many times because an appropriate amplified region cannot be selected, thereby facilitating the operation of the user and improving the user experience.

What is claimed is:

1. A method for amplifying a selected region of a preview interface, applied to a touch screen terminal having a photographing function or/and a shooting function, comprising:
after the photographing function or the shooting function of the terminal is enabled and the preview interface is displayed on a touch screen, detecting a touch operation of a user on the preview interface; and
after the touch operation of the user in a designated region on the preview interface is detected, amplifying a display content of the designated region according to a preset proportion.

2. The method according to claim 1, wherein after amplifying a display content of the designated region according to a preset proportion, the method comprises: displaying the amplified display content of the designated region on the touch screen.

3. The method according to claim 1, wherein,
after the touch operation of the user in a designated region on the preview interface is detected, amplifying a display content of the designated region according to a preset proportion comprises:
after the touch operation of the user in the designated region on the preview interface is detected, focusing on a center of the designated region; and
after the center of the designated region is focused and a clear display content is obtained, amplifying the display content.

4. The method according to claim 2, wherein after the amplified display content of the designated region is displayed on the touch screen, the method comprises:
detecting whether there is a touch operation on an edge of the amplified designated region; and
if yes, enlarging or reducing the designated region according to a displacement trajectory of the touch operation.

5. The method according to claim 2, wherein after the amplified display content of the designated region is displayed on the touch screen, the method comprises:
detecting whether there is a touch operation within the amplified designated region;
if yes, determining a type of the touch operation; and
enlarging or reducing the designated region in accordance with a preset coefficient according to the type of the touch operation.

6. The method according to claim 4, wherein detecting whether there is a touch operation on an edge of the amplified designated region comprises:
after a press-down operation and a lift-up operation of the user on the touch screen are detected, recording coordinates of the press-down operation and the lift-up operation on the touch screen;
judging whether the coordinates of the press-down operation are on the edge of the amplified designated region; and
if the coordinates of the press-down operation are on the edge of the amplified designated region, determining that the touch operation is on the edge of the designated region and determining the displacement trajectory.

7. The method according to claim 5, wherein detecting whether there is a touch operation within the amplified designated region and if yes, determining a type of the touch operation comprises:
after a press-down operation and a lift-up operation of the user on the touch screen are detected, recording coordinates of the press-down operation and the lift-up operation on the touch screen;
if the coordinates of the press-down operation are within the amplified designated region, calculating a number of times of the press-down operation within the amplified designated region for a preset period of time; and
determining the type of the touch operation according to the number of times of the press-down operation.

8. An apparatus for amplifying a selected region of a preview interface, comprising:
a touch operation detection module configured to detect a touch operation of a user on the preview interface after a photographing function or a shooting function of a terminal is enabled and the preview interface is displayed on a touch screen; and
an amplification module configured to amplify a display content of a designated region on the preview interface according to a preset proportion after the touch operation of the user in the designated region is detected by the touch operation detection module.

9. The apparatus according to claim 8, wherein,
the touch operation detection module is further configured to detect a press-down operation and a lift-up operation of the user on the touch screen, and record coordinates of the press-down operation and the lift-up operation on the touch screen; and
the apparatus further comprises a display module configured to display the display content amplified by the amplification module on the touch screen.

10. The apparatus according to claim 8, further comprising: a region enlargement/reduction module configured to, when there is a touch operation on an edge of the amplified designated region, enlarge or reduce the designated region according to a displacement trajectory of the touch operation; or
when there is a touch operation within the amplified designated region, determine a type of the touch operation, and enlarge or reduce the designated region in accordance with a preset coefficient according to the type of the touch operation.

11. The method according to claim 2, wherein,
after the touch operation of the user in a designated region on the preview interface is detected, amplifying a display content of the designated region according to a preset proportion comprises:
after the touch operation of the user in the designated region on the preview interface is detected, focusing on a center of the designated region; and
after the center of the designated region is focused and a clear display content is obtained, amplifying the display content.
